(19) United States
(12) Patent Application Publication
(10) Pub. No.: US 2004/0117236 A1
(43) Pub. Date: Jun. 17, 2004

(54) Automated optimization tool for electric utility sypply services

(76) Inventors: Dharmashankar Subramanian, St. Anthony, MN (US); Vipin Gopal, Manchester, CT (US); Anoop K. Mathur, Shoreview, MN (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/319,029

(22) Filed: Dec. 13, 2002

(51) Int. Cl. G06F 17/60

(52) U.S. Cl. 705/10; 705/412

(57) ABSTRACT

In order to determine a lowest utility cost relative to a plurality of utility rate structures and a Contract Base Load, a plurality of utility costs are computed such that each of the utility costs corresponds to a different combination of one of rate structures and the Contract Base Load. These computations are based on an objective function. A rate structure and Contract Base Load combination corresponding to the lowest utility cost is presented to a utility customer who may then negotiate a utility contract based on the present information. If desired, the computations may also be based on various on-site generation options.

### TECHNICAL FIELD OF THE INVENTION

The present invention relates to the optimization of the purchase of power from a utility.

### BACKGROUND OF THE INVENTION

Currently, there are no efficient tools to help electric utility customers negotiate superior energy contracts with electric utility companies. Utility customers have a wealth of historical data about their energy requirements and about real time prices of energy. Although this data could help them in determining optimum contract terms, there are no tools to assist electric utility customers in using such data to choose a rate structure and to specify a Contract Base Load (CBL) so that the customers can intelligently enter into power supply contracts with their electric utilities.

Moreover, on-site generation of electrical power is an option to many customers. However, complex issues face these customers in determining whether on-site generation of electrical power is a viable alternative to the purchase of power from electric utilities. For example, customers must determine whether on-site generation equipment should be acquired and how much to invest in the acquisition of on-site generation equipment. Moreover, the purchase of such equipment raises additional questions affecting these investment decisions such as determining when such on-site generation equipment should be engaged, and the extent to which the on-site generation equipment should be engaged. It is also necessary to determine the cost of running and maintaining the on-site generation equipment.

These decisions need to be made so as to minimize the total annual cost of electrical power to the customer. The total annual cost of electrical power is based on (a) the pricing logic of the rate structure (that typically includes an energy charge and a demand charge) relative to the Contract Base Load, (b) the cost of purchasing energy at the real time price, (c) any capital investment that is required for on-site generation equipment, and (d) the costs of operating and maintaining on-site generation equipment.

As can be seen, these decisions present electric utility customers with a complex commercial problem. Unfortunately, current tools that are intended to help these customers deal with this complex problem are too simple to be of significant use. Indeed, many customers would rather rely on their instincts and experience in making these decisions.

The present invention, in one of its embodiments, offers a more rigorous tool to help utility customers deal with the complexities of determining the most cost effective terms in power supply contracts.

### SUMMARY OF THE INVENTION

In accordance with one aspect of the present invention, a method is provided to determine a lowest utility cost relative to a plurality of utility rate structures, to an estimated customer load, and to a temporal resolution of a Contract Base Load. The method comprises the following: computing a plurality of utility costs based on combinations of each of the rate structures, the estimated customer load, and the temporal resolution of the Contract Base Load; and, selecting the rate structure and Contract Base Load producing the lowest utility cost.

In accordance with another aspect of the present invention, a computer implemented method of determining a lowest utility cost relative to a plurality of utility rate structures and an estimated customer load comprises the following: computing a plurality of utility costs based on the plurality of utility rate structures and the estimated customer load such that each of the utility costs corresponds to a different combination of one of the utility rate structures and a Contract Base Load, wherein the computing of the plurality of utility costs is further based on a minimization of an objective function; and, providing to a utility customer a rate structure and Contract Base Load combination corresponding to the lowest utility cost.

In accordance with still another aspect of the present invention, a computer implemented method is provided to determine a lowest utility cost relative to a plurality of utility rate structures, to an estimated customer load, and to a plurality of on-site generation options. The method comprises the following: computing a plurality of utility costs such that each of the utility costs corresponds to a different combination of one of rate structures, a Contract Base Load, and one of the on-site generations options, wherein the computing of the plurality of utility costs is based on an objective function; and, presenting to a utility customer a rate structure, a Contract Base Load, and on-site generation option combination corresponding to the lowest utility cost.

In accordance with still another aspect of the present invention, a method is provided to determine a lowest utility cost for a plurality of customers relative to a plurality of utility rate structures, to a total estimated load corresponding to the plurality of customers, and to a temporal resolution of a Contract Base Load. The method comprises the following: computing a plurality of utility costs based on combinations of each of the rate structures, the estimated total customer load, and the temporal resolution of the Contract Base Load; and, selecting the rate structure and Contract Base Load producing the lowest utility cost.

### BRIEF DESCRIPTION OF THE DRAWINGS

These and other features and advantages will become more apparent from a detailed consideration of the invention when taken in conjunction with the drawings in which:

FIG. 1 illustrates a computer system that can implement the present invention in at least one of its embodiments;

FIG. 2 illustrates an exemplary Contract Base Load for one day;

FIG. 3 illustrates a block diagram of an exemplary computational architecture that may be used to search for input values to the optimization procedure of the present invention; and,

FIG. 4 illustrates a program to determine the lowest annual cost relative to a utility based on one or more the objective functions described below.

### DETAILED DESCRIPTION

A computer system 10 offers an exemplary environment for the execution of the optimization procedures involved in the present invention. The computer system 10 includes a computer 12 coupled to an input device 14, an output device 16, a random access memory (RAM) 18, and a read only memory (ROM) 20. The input device 14 may include a keyboard, a mouse, both a keyboard and a mouse, or any other one or more input devices suitable for use with a computer. The output device 16 may be a computer screen, a printer, both a computer screen and a printer, or any one or more other output devices suitable for used with a computer. The RAM 18 may be a disk, a semiconductor memory, both a disk and a semiconductor memory, or any one or more other memories suitable for used with a computer. The ROM 20 may likewise be any one or more memory devices suitable for used with a computer.

The computer system 10 executes a cost optimization procedure that incorporates optimization techniques and algorithms of an automated tool permitting electric utility customers to acquire cost effective electrical power. In one embodiment of the present invention, the utility customer is required to enter three data inputs into the computer system 10, a customer's load estimate, a set of rate structures offered by the utility, and a temporal resolution for the Contract Base Load to be determined by the optimization procedure.

A customer's load estimate represents a one-year-ahead expected energy requirement (kWh) of the customer. This profile can be based on one hour increments, and the forecasted profile can be converted into a corresponding kW profile for every one hour bucket. Alternatively, any other time increment of choice may be used for the forecast. The customer's load estimate may be based on the customer's historical demand data and may be generated by any utility demand forecasting module and/or predictive model available to the customer.

The set of rate structures is obtained from the utility. Examples of rate structures include (i) a standard rate structure composed of a demand charge and an energy consumption charge, irrespective of usage time-of-day, (ii) a time-of-use rate structure that is composed of a demand charge and an energy cost varying according to the time of the day (usually peak, mid-peak, and off-peak) and the time of the year (usually summer and winter), and (iii) a real time price structure, i.e. the customer purchases electricity as needed at a spot price from the wholesale market. The temporal resolution of the Contract Base Load must also be entered. This resolution is typically determined by the utility.

Accordingly, in managing the electric utility requirements, the utility customer has two degrees of freedom (assuming that the possible acquisition of on-site generation capability is, for the moment, ignored). These degrees of freedom are (i) to pick a rate structure from the set of allowable rate structures, and (ii) to pick a pre-negotiated demand profile, known as the Contract Base Load (CBL) profile. The Contract Base Load profile may be fully specified for the entire year by choosing the load levels for the following time periods: peak, middle-peak, and off-peak periods for each day of the week during both summer and winter. Accordingly, there are a total of 3×7×2=42 possible load levels.

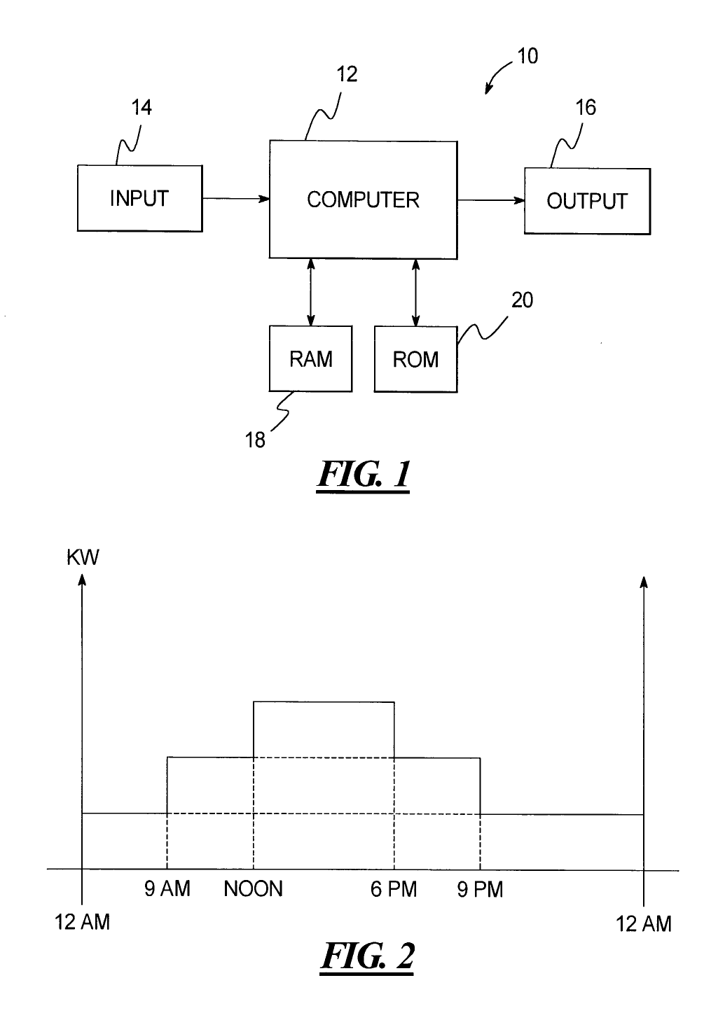

FIG. 2 shows an example of a Contract Base Load profile for, say, all the Mondays during at least one of the summer and winter seasons. As shown in the example of FIG. 2, the pre-negotiated electricity usage level is different for the peak (noon to 6:00 PM), mid-peak (9:00 AM to noon and 6:00 PM to 9:00 PM), and off-peak (9:00 PM to 9:00 AM) periods of the day. The use of these periods as the temporal resolution of the Contract Base Load gives the pre-negotiated Contract Base Load profile a block looking structure.

The annual energy cost is generally composed of an energy cost and a demand charge. The energy cost applies to the total consumption (in kWh) that the customer has pre-negotiated (by specifying the Contract Base Load) over the entire year. This cost is calculated using the Contract Base Load kwh-versus-time profile and the applicable pre-negotiated rate ($/kWh), irrespective of the actual usage of the customer. Any difference between the Contract Base Load and actual use is credited/debited at the real time price of energy corresponding to the time periods where the two profiles differ. In other words, if the customer actually utilizes less than the pre-negotiated Contract Base Load at any time during the year, the utility credits the customer with the difference in energy (kWh) at the real time price of electric energy for that time. On the other hand, if the customer utilizes more than the pre-negotiated Contract Base Load at any time during the year, the customer purchases energy at the corresponding real time price of energy.

The demand charge is assessed on a monthly basis using the pre-negotiated rate for demand (in $/kW). For example, if a time-of-use rate structure is used, the demand charge is assessed for each of the peak, mid-peak and off-peak periods for the month. Further, the demand charge is based on the higher of (i) the highest actually utilized demand (kW) over 1-hour time buckets and (ii) the highest pre-negotiated Contract Base Load profile that applies to the corresponding time-of-use in the corresponding month. (In the example considered herein, it is being assumed that the maximum utilized demand is considered over 1-hour time buckets. However, the maximum utilized demand could just as easily be considered over 15-minute time buckets or buckets of other time periods).

The annual cost resulting from the above-decisions (rate structure and Contract Base Load) to the customer is modeled as described below. A time-of-use rate structure is used for illustrating the calculation of the cost. However, other rate structures can be used. First, notations L, M, N, and K are defined as follows:

L={Mid-Peak, Off-Peak, Peak}

M={Summer, Winter}

N={Mon, Tue, Wed, Thu, Fri, Sat, Sun}

K={Jan, Feb, Mar, . . . , Dec}.

Set L includes the partitions of the day into peak, middle-peak, and off-peak time periods. Sets M, N and K are self-explanatory. Let Cₗₘ be the time-of-use energy charge in units of $/kWh, and let Dₗₘ be the time-of-use demand charge in units of $/kW (where l stands for the time of the day such that l∈L, and m stands for the time of the year such that m∈M).

The components that contribute to the overall annual cost include an energy cost, a demand charge, and a charge (or credit) that the customer incurs based on actually consumed power. Let it be assumed that electric consumption over the entire year is based on one-hour time intervals, and let dᵢ be the load (in kW) corresponding to the hourly time bucket i, where I is the set of hourly time intervals in the entire year, and where i∈l. The load dᵢ is obtainable from the estimated customer load (e.g., the forecasted-kWh energy usage based on historical data) corresponding to time bucket i by simple averaging.

The overall annual cost results from the total energy consumption (kWh), and is based on the customer's pre-negotiated Contract Base Load over the year. This energy consumption is charged at rates corresponding to the time of the year and the time of the day that the energy has been consumed. Let hₗₘₙ represent the Contract Base Load (in kW) that is negotiated by the utility customer (where n stands for the day of the week such that n∈N). If one-hour time intervals of over the entire year are considered, the first component of the overall annual cost is the energy cost and is modeled as follows:

$${\sum }_{l ∈ L} {\sum }_{m ∈ M} {\sum }_{n ∈ N} {\sum }_{i ∈ {T}_{lmn}} {C}_{l m} * {h}_{lmn}$$

where Cₗₘ is the time-of-use energy rate in units of $/kWh, as discussed above, and where the set Tₗₘₙ is the set of those hourly time-periods (of the entire year) that are characterized by time-of-the-day l, time-of-the-year m, and day of the week n. The set Tₗₘₙ is pair-wise disjoint such that

$${⋃}_{l , m , n} {T}_{lmn} = I .$$

The second component of the overall annual cost is the total demand charge and is modeled as:

$${\sum }_{l ∈ L} {\sum }_{k ∈ K} {D}_{lS ( k )} * Max ( {Max}_{i ∈ {T}_{lk}} \{ {d}_{i} \} , {Max}_{n ∈ N} \{ {h}_{lS ( k ) n} \} ) = {\sum }_{l ∈ L} {\sum }_{k ∈ K} {D}_{lS ( k )} * {Max}_{i ∈ {T}_{lk} , n ∈ N} ( {d}_{i} , {h}_{lS ( k ) n} )$$

where the set Tₗₖ is the set of those hourly time-periods (of the entire year) that are characterized by time-of-the-day l and month k, where k∈K. The set Tₗₖ is pair-wise disjoint such that

$${⋃}_{l , k} {T}_{lk} = I .$$

S(k) maps the set K to the set M, i.e. S(k) denotes the season m (summer/winter) for month k. In other words, the demand charge is assessed on a monthly basis, for each of the peak, mid-peak, and off-peak periods of the month. The demand charge is based on the higher of the highest estimated customer load and the highest pre-negotiated Contract Base Load for that month and for each of these peak periods.

The third component of the overall annual cost is based on the charge that the customer incurs based on the profile of the estimated customer load, if greater than the Contract Base Load. This charge is assessed at the real time price (or spot price) of electric energy. Let Rᵢ be the real time price of energy corresponding to the hourly time-bucket i. This charge is then modeled as:

$${\sum }_{l ∈ L} {\sum }_{m ∈ M} {\sum }_{n ∈ N} {\sum }_{i ∈ {T}_{lmn}} Max [ 0 , ( {d}_{i} - {h}_{lmn} ) ] * {R}_{i}$$

As discussed above, dᵢ represents the estimate customer load (in kW) corresponding to the hourly time bucket i, hₗₘₙ represents the Contract Base Load profile (in kW), and the Tₗₘₙ is the set of those hourly time-periods that are characterized by time-of-the-day l, time-of-the-year m, and day of the week n. It should be noted that this third component could alternatively result in a credit. That is, an extra charge is assessed to the customer if dᵢ>hₗₘₙ, whereas a credit is given the customer if dᵢ<hₗₘₙ.

A first objective function can be created by summing these three components. Minimizing this objective function minimizes the annual cost of energy. Accordingly, the computer 12 inserts various combinations of the rate structures (Cₗₘ, Dₗₘ, and Rᵢ) and the Contract Base Load (hₗₘ) into the objective function and selects the combination yielding the lowest annual energy cost. The rate structure and Contract Base Load producing the minimum cost is the basis for the customer's negotiation with the utility.

An additional design degree of freedom that the customer has in managing utility requirements is the choice of acquiring on-site generation capability at a suitable capacity. This choice, however, involves the cost of a corresponding capital expenditure. This capital expenditure can be modeled as a constant “Demand Charge” that applies every month on a $/kW basis (per kW of acquired capacity).

The customer also must decide when to use this on-site generation capability. Such on-site energy generation effectively modifies the demand profile that the customer presents to the electric utility (i.e. the demand profile, dᵢ, i∈I, which appears in the annual cost modeling as discussed above). The choice of when-to-use and how-much-to-use with respect to on-site generation is an operational degree of freedom that the customer can use to minimize the annual electric utility costs.

Based on the above discussion, there exists an opportunity to use optimization techniques and algorithms to answer the following questions: which rate structure offered by the utility should be chosen? what Contract Base Load should be negotiated? should on-site generation be acquired and, if so, how much? and, during what periods of year should on-site generation be used?

These questions need to be answered with the objective of minimizing the customer's annual utility cost.

The following describes a refined mathematical programming formulation of the cost minimization problem. The following formulation initially assumes no onsite generation. The notation and indices used in this formulation has been changed to denote a demarcation between this formulation and the formulation given above. For purposes of computational efficiency, the mathematical program is modeled as a linear program with only continuous variables to overcome the nonlinearities present in the modeling of the costs discussed above.

Let Iₘ={1, 2, . . . , 12} be the set of months, J_{w}={1, 2, . . . , 7} be the set days in the week, and Kₕ={1, 2, . . . , 24} be the set of hours in a day. The decision variables include hᵢⱼₖ, d_{ijkq}, and zᵢₗ.

The decision variable hᵢⱼₖ is defined as a non-negative, continuous variable for the Contract Base Load (kWh) that is contracted for month I where i∈Iₘ, for week-day j where j∈J_{w}, and for hour k where k∈Kₕ. This definition allows the Contract Base Load to be defined in terms of the resolution offered by a utility. For example, the finest level of resolution occurs when each hour (in set Kₕ) of each weekday (in set J_{w}) corresponding to each month (in set Iₘ) has an independently chosen Contract Base Load. Accordingly, multiple occurrences of the same weekday, say Monday, within any given month, say June, would have the same hourly profile at this level of resolution.

The decision variable d_{ijkq} is defined as a non-negative, continuous variable, and is used to model the amount of energy (kWh) that is purchased at the corresponding real time price for the q^{th} occurrence of the weekday j, during hour k, in month i, where q∈Q(i,j,k), and where the set Q(i,j,k) is the set of occurrences of any given (i,j,k). Accordingly, d_{ijkq} is the difference between hᵢⱼₖ and the energy actually consumed by the customer, which in this case is the estimated customer load. It is noted that any given weekday has multiple occurrences (at most 5) in any given month. Also, it is noted that subscripts i, j, k, and q span every hour in the whole year. Accordingly, hourly values for energy requirements and real time prices for the entire year can be indexed using these four subscripts, i.e. via Dm_{ijkq} that denotes the hourly value for the customer's energy requirements for the q^{th} occurrence of the weekday j during hour k in month i, and R_{ijkq} that denotes the real time price of energy for the q^{th} occurrence of the weekday j during hour k in month i, where Dm_{ijkq} and R_{ijkq} are in appropriate units.

The decision variable zᵢₗ is defined as a non-negative, continuous variable that models the highest estimated demand (in kW, for assessing demand charges) in peak period l where l∈L, in month i.

Several constraints are imposed on the mathematical programming formulation of the objective function. For example, a first constraint is given by the following inequality:

hᵢⱼₖ+d_{ijkq}≧Dm_{ijkq}

where ∀ i∈Iₘ, j∈J_{w}, k∈Kₕ, and q∈Q(i,j,k). This constraint requires satisfaction of the hourly energy requirements. It is noted that this constraint should not be formulated as an equality constraint for all q corresponding to any given (i,j,k). Doing so would unnecessarily constrain the variable hᵢⱼₖ, and would lead to potentially sub-optimal solutions.

A second constraint may be given by the following inequality:

zᵢₗ≧Hᵢⱼₖ

where ∀ i∈Iₘ, j∈J_{w}, k∈Kₕ(i,j,l), l∈L, and where Kₕ(i,j,l)⊂Kₕ. Thus, the set Kₕ(i,j,l) represents a subset of the set Kₕ and contains hours that correspond to peak period l, in month i, and day j. This constraint is one of two constraints that model the maximum demand. It is noted that a constant of one hour is implicit in this dimensionally consistent inequality in order to translate hᵢⱼₖ in kWh to kW. In other words, it is assumed that the energy consumption hᵢⱼₖ in the Contract Base Load occurs uniformly over the corresponding hour.

A third constraint may be given by the following equation:

zᵢₗ≧Max{over j∈J_{w},k∈Kₕ(i,j,l),q ∈Q(i,j,k)}(Dm_{ijkq})

where ∀ i∈Iₘ, and l∈L. This constraint is the second of the two constraints that model the maximum demand. As in the first of the two constraints that model the maximum demand, it is assumed that the energy demand, Dm_{ijkq}, is consumed uniformly over the corresponding hour.

Finally, the hᵢⱼₖ, d_{ijkq}, and zᵢₗ variables are constrained to be non-negative numbers.

All of the above constraints are linear and involve continuous variables. Along with the objective function, they also effectively model the nonlinearities present in the costs set out above.

It is noted that the definition of the variable hᵢⱼₖ given above leads to a fine resolution for constructing the Contract Base Load. If a coarser resolution is desired, additional constraints that require an appropriate subset of the variable hᵢⱼₖ to be equal would be necessary. For example, if the Contract Base Load resolution at the hourly level needs to match the given rate structure (in terms of peak periods), while being independent at the month and weekday levels, the following constraints can be implemented to produce this coarser resolution:

hᵢⱼₖ=h_{ijk′}

if ∃ l∈L, such that {k,k′}⊂Kₕ(i,j,l).

A second objective function can be formulated as the total annual cost and comprises three terms. Optimization requires minimization of the objective function.

The first term of the objective function is given by the following expression:

$${\sum }_{i ∈ {I}_{m} , j ∈ {J}_{w} , k ∈ {K}_{h}} {h}_{ijk} * {E}_{ijk} * \vert {Q}_{ijk} \vert$$

This term models the consumption charge based on the Contract Base Load. The | | denotes cardinality, and Eᵢⱼₖ is the energy (or consumption) charge (in appropriate units) that is charged for weekday j, during hour k, in month i, for the given rate structure.

The second term of the objective function is given by the following expression:

$${\sum }_{i ∈ {I}_{m} , j ∈ {J}_{w} , k ∈ {K}_{h} , q ∈ Q ( i , j , k )} {d}_{ijkq} * {R}_{ijkq}$$

This term models the cost of the energy purchased at the real time price R_{ijkq}.

The third term of the objective function is given by the following expression:

$${\sum }_{i ∈ {I}_{m} , l ∈ L} {z}_{il} * {P}_{il}$$

This term models the demand charge corresponding to month i and peak period l. Pᵢₗ is the rate (in appropriate units) at which the demand charge is assessed in the given cost structure.

It is noted that Eᵢⱼₖ, R_{ijkq}, and Pᵢₗ are all positive quantities which, along with the constraints, the objective function, and the minimization of the objective function, effectively capture the nonlinearities in the annual cost modeling in a linear fashion.

Accordingly, the objective function based on the three terms set out above is given by the following expression:

$${\sum }_{i ∈ {I}_{m} , j ∈ {J}_{w} , k ∈ {K}_{h}} {h}_{ijk} * {E}_{ijk} * \vert {Q}_{ijk} \vert + {\sum }_{i ∈ {I}_{m} , j ∈ {J}_{w} , k ∈ {K}_{h} , q ∈ Q ( i , j , k )} {d}_{ijkq} * {R}_{ijkq} + {\sum }_{i ∈ {I}_{m} , l ∈ L} {z}_{il} * {P}_{il}$$

Therefore, as discussed above, the optimization of the total annual cost to the customer is obtained by minimizing this objective function. Minimizing this second objective function minimizes the annual cost of energy. Accordingly, the computer 12 inserts various combinations of the rate structures and the Contract Base Load into the second objective function and selects the combination yielding the lowest annual energy cost. The rate structure and Contract Base Load producing the minimum cost is the basis for the customer's negotiation with the utility. This optimization is subject to the following constraints:

hᵢⱼₖ+d_{ijkq}≧Dm_{ijkq}

where ∀ i∈Iₘ, j∈J_{w}, k∈Kₕ, with q∈Q(i,j,k);

zᵢₗ≧hᵢⱼₖ

where ∀ i∈Iₘ, j∈J_{w}, k∈Kₕ(i,j,l) and l∈L;

zᵢₗ≧Maximum{over j∈J_{w},k∈Kₕ(i,j,l),q∈Q(i,j,k)}(Dm_{ijkq})

where ∀ i∈Iₘ, and l∈L;

hᵢⱼₖ≧0

where ∀ i∈Iₘ, j∈J_{w}, k∈Kₕ;

d_{ijkq}≧0

where ∀ i∈Iₘ, j∈J_{w}, k∈Kₕ, with q∈Q(i, j, k); and,

zᵢₗ≧0

where ∀ i∈Iₘ and l∈L, and subject to the following definitions: Iₘ={1,2, . . . ,12} is the set of months; J_{w}={1,2, . . . ,7} is the set of week-days; Kₕ={1,2, . . . , 24} is the set of hours (in any day); set Q(i,j,k) is the set of occurrences of any given (i,j); Kₕ(i,j,l) represents that subset of Kₕ containing hours that correspond to peak period l, in month i, and day of the week j; Dm_{ijkq} and R_{ijkq} are the hourly energy demand and the real time prices in appropriate units; Eᵢⱼₖ is the energy (or consumption) rate (in appropriate units) that applies for day of the week j, during hour k, in month i, and in the given rate structure; and, Pᵢₗ is the rate (in appropriate units) at which the demand charge is assessed in the given rate structure.

The following data is exemplary of the data that might be presented to a customer in a cost optimization problem. The customer develops an hourly forecast of expected load demand (kW), along with an hourly forecast of expected real time prices, for the entire year using any available forecasting algorithm.

A utility may offer the customer two different rate structures from which to choose. A first rate structure may be a standard rate structure that includes the following rates: an energy cost of 8.915 c/kWh in Summer; an energy cost of 7.279 c/kWh in Winter; a demand cost of 6.70 $/kW in Summer; a demand cost of 1.65 $/kW in Winter; and, a fixed customer charge of 75 $/month, where summer is May 1-October 31 and winter is November 1-April 30.

A second rate structure may be a time-of-use rate structure that includes the following rates: an energy cost of 8.773 c/kWh in peak summer; an energy cost of 5.810 c/kWh in mid-peak summer; an energy cost of 5.059 c/kWh in off-peak summer; no applicable energy in peak winter; an energy cost of 6.392 c/kWh in mid-peak winter; an energy cost of 5.038 c/kWh in off-peak winter; a demand cost of 13.35 $/kW peak summer; a demand cost of 3.70 $/kW mid-peak summer; a demand cost of 2.55 $/kW off-peak summer; no applicable demand cost in peak winter; a demand cost of 3.65 $/kW in mid-peak winter; a demand cost of 2.55 $/kW in off-peak winter; and, a fixed customer charge of 175 $/month, where summer is May 1-October 31, summer peak is 12:00 Noon-6:30 PM Monday through Friday, summer mid-peak is 8:00 AM-12:00 Noon and 6 PM-9 PM Monday through Friday, summer off-peak is 9 PM-8 AM Monday through Friday, the same summer rate is used all day for Saturdays, Sundays, and holidays, winter is November 1-April 30, winter peak has NO PEAK PERIOD, winter mid-peak is 8 AM-9 PM Monday through Friday, winter off-peak is 9 PM-8 AM Monday through Friday, the same winter rate is used all day for Saturdays, Sundays, and holidays.

If the rates as given above change depending upon the negotiated Contract Base Load, such information is required to make the optimization formulation complete.

Based on this information, the optimization model picks the best rate structure and pre-negotiated Contract Base Load to minimize the annual electric utility cost.

When on-site generation is considered, both design and operational aspects need to be addressed in the optimization. Additional decision variables relative to these aspects must be formulated when on-site generation is added to the optimization determination.

One of these additional variables is an energy capacity variable Gas_Cap that is defined as a non-negative, continuous variable that models the design aspect of on-site generation. This variable represents the decision of how much capacity (in kW) to acquire on-site.

The other of the additional variables is a use variable g_{ijkq} that is defined as a non-negative, continuous variable that models the operational aspect of on-site generation. This variable represents the amount of energy (kWh) that is generated on-site for the q^{th} occurrence of the weekday j, during hour k, in month i, and q∈Q(i,j,k), where set Q(i,j,k) is the set of occurrences of any given (i,j,k). The on-site generation equipment can be operated at any level up to system capacity, and the extent of on-site generation may vary from hour to hour.

The cost resulting from the incorporation of on-site generation has two components. One cost component Fᵢ is cost of capital depreciation and maintenance. Specifically, a capital investment is made for the purchase of on-site generation capacity that needs to be accounted for as costs of depreciation and maintenance. This cost can be modeled as a monthly cost per unit capacity ($/kW) that is installed in the system. It should be noted that this way of modeling the capital depreciation and maintenance cost is similar to the way utility companies attach a demand charge to consumers.

The other cost component A_{ijkq} is the operational cost. The cost of operating the on-site generation entails the purchase of gas. The cost of gas needs to be reflected in the operational cost. Assuming a conversion efficiency of gas energy in MBtu (Million British Thermal Units) to electric energy in kWh of around 33%, the cost of gas in cents/MBtu can be translated to a corresponding cents/kWh of on-site energy generation.

The constraints described above need to reflect the presence of on-site generation. Therefore, the constraint set is re-defined as follows to take into account on-site generation. In this re-definition, it is again assumed that the energy demand over any corresponding one hour period occurs uniformly.

The first constraint as set out above is re-defined as follows:

hᵢⱼₖ+d_{ijkq}+g_{ijkq}≧Dm_{ijkq}

where ∀ i∈Iₘ, j∈J_{w}, k∈Kₕ, with q∈Q(i,j,k). This constraint insists that the hourly energy requirements be satisfied. It is noted that this constraint should not be an equality constraint for all q corresponding to any given (i,j,k). Doing so would unnecessarily constrain the variable hᵢⱼₖ, and would lead to potentially sub-optimal solutions.

The second constraint as set out above requires no re-definition but is repeated as follows for convenience:

zᵢₗ≧hᵢⱼₖ

where ∀ i∈Iₘ, j∈J_{w}, k∈Kₕ(i,j,l), and l∈L, and where Kₕ(i,j,l) ⊂Kₕ. Kₕ(i,j,l) represents that subset of Kₕ containing the hours that correspond to the peak period l, in month i, and day of the week j. As discussed above, the constraint is one of two constraints that model the maximum demand.

The third constraint as set out above is re-defined as follows:

zᵢₗ+g_{ijkq}≧Dm_{ijkq}

where ∀ i∈Iₘ, j∈J_{w}, l∈L, k∈Kₕ(i,j,l), and q∈Q(i,j,k). Also, as discussed above, this constraint is the second of the two constraints that model the maximum demand.

A fourth constraint is defined as follows:

g_{ijkq}≦Gas_{—}Cap

where ∀ i∈Iₘ, j∈J_{w}, k∈Kₕ, with q∈Q(i,j,k). This constraint models the capacity limit when the on-site generation is engaged.

The objective function described above needs to be augmented with the following two additional cost contributions to produce a third objective function. The first additional cost contribution is given by the following expression:

$${\sum }_{i ∈ {I}_{m} , j ∈ {J}_{w} , k ∈ {K}_{h} , q ∈ Q ( i , j , k )} {g}_{ijkq} * {A}_{ijkq}$$

This expression models the cost of the gas that is purchased for operating the on-site generation. The term A_{ijkq} is the cost rate (in appropriate units per unit of energy generation) for generating energy on-site by consuming gas. For the current analysis, this rate is assumed to be a constant.

The second additional cost contribution is given by the following expression:

$${\sum }_{i ∈ {I}_{m}} {F}_{i} * Gas\_Cap$$

This expression models the cost of capacity acquisition in the same manner as demand charges are assessed. A capital depreciation cost of Fᵢ per unit capacity (kW) is charged for month i.

The remaining terms in the objective function are the same as given above.

Accordingly, as modified for on-site generation, the objective function based on the five terms set out above is given by the following expression:

$${\sum }_{i ∈ {I}_{m} , j ∈ {J}_{w} , k ∈ {K}_{h}} {h}_{i j k} * {E}_{i j k} * \vert {Q}_{i j k} \vert + {\sum }_{i ∈ {I}_{m} , j ∈ {J}_{w} , k ∈ {K}_{h} , q ∈ Q ( i , j , k )} {d}_{i j k q} * {R}_{i j k q} + {\sum }_{i ∈ {I}_{m} , l ∈ L} {z}_{i l} * {P}_{i l} + {\sum }_{i ∈ {I}_{m} , j ∈ {J}_{w} , k ∈ {K}_{h} , q ∈ Q ( i , j , k )} {g}_{i j k q} * {A}_{i j k q} + {\sum }_{i ∈ {I}_{m}} {F}_{i} * Gas\_Cap$$

Therefore, as discussed above, the optimization of the total annual cost to the customer is obtained by minimizing this objective function with respect to the rate structures, the Contract Base Load, the energy capacity variable Gas_Cap, and the use variable g_{ijkq}, subject to the following constraints:

hᵢⱼₖ+d_{ijkq}+g_{ijkq}≧Dm_{ijkq}

zᵢₗ≧hᵢⱼₖ

hᵢⱼₖ≧0

d_{ijkq}≧0

zᵢₗ≧0

Gas_{—}cap≧0

g_{ijkq}≧0

where ∀ i∈Iₘ, j∈J_{w}, k∈Kₕ(i,j,l), l∈L, and q∈Q(i,j,k).

There are sources of uncertainty that make the optimization formulation discussed above a stochastic optimization problem. A computational framework is presented here for tackling the stochastic optimization by integrating the individual merits of mathematical programming, Monte-Carlo simulation, and heuristic search techniques such as Scatter Search, Tabu Search, and Genetic Algorithms.

As noted above, the input into the optimization function includes an hourly forecast of the estimated customer load requirements and the expected real time price of electricity. Both these inputs are subject to uncertainty and are, therefore, interval estimates, which are quantified respectively by probability distributions as opposed to point estimates. Minimization of the deterministic optimization function seeks the optimal choice of the rate structure and the specification of a Contract Base Load that goes with the rate structure for the deterministic objective of minimizing the annual cost. Clearly, any choice of rate structure along with a Contract Base Load will imply a distribution of the resulting annual cost due to the uncertainties noted above.

In the face of such uncertainty, a stochastic objective function becomes more relevant. Such a stochastic objective function needs to target the interval aspect of the annual cost distribution, as opposed to the point aspect (as in say, the central tendency, or expected value, of the annual cost distribution). Examples of stochastic objectives include those that minimize the variance of the resulting cost distribution, or maximize the probability of cost being less than a predetermined value.

It is noted that the uncertainty in objective functions described above arises from the input data, when viewed in the context of deterministic mathematical programming formulations. Different combinations of the individual realizations of the various stochastic input parameters would lead to different instances of the deterministic mathematical programming formulation. In turn, these different instances would lead to different deterministic optimal solutions, which in turn, when simulated in the face of uncertainties, would lead to different annual cost distributions, or in other words, different values for the stochastic objective function of interest.

One way to retain the merits of the deterministic optimization formulation would be to search for the “right” set of input values to use as the deterministic input for the deterministic math program. The resulting deterministic formulation instance yields an optimal solution, which leads to a desirable stochastic objective when simulated in the face of uncertainty.

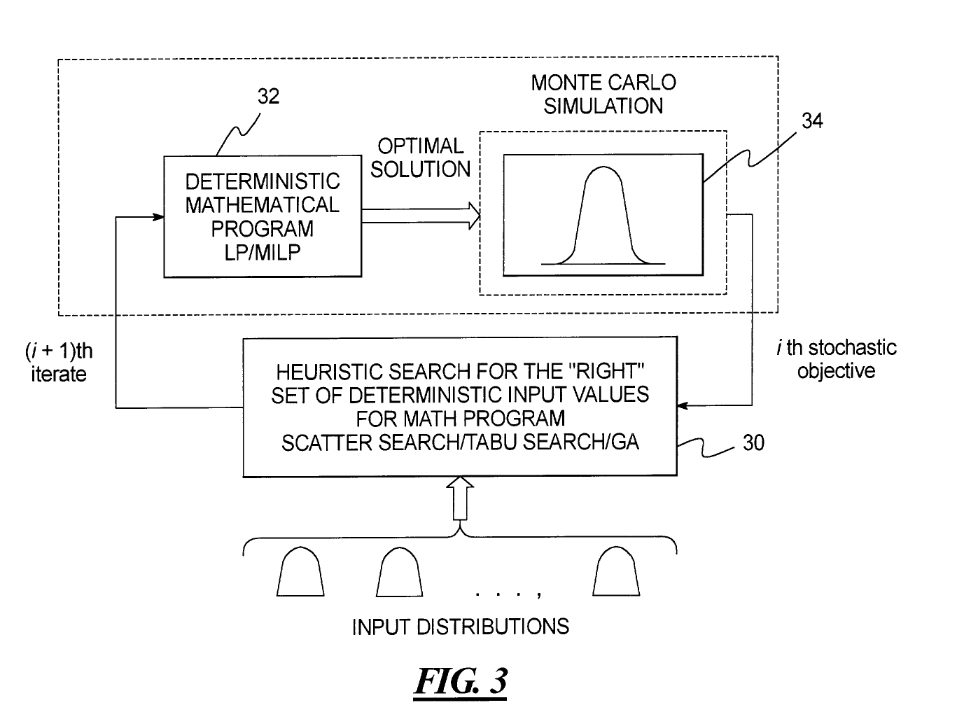

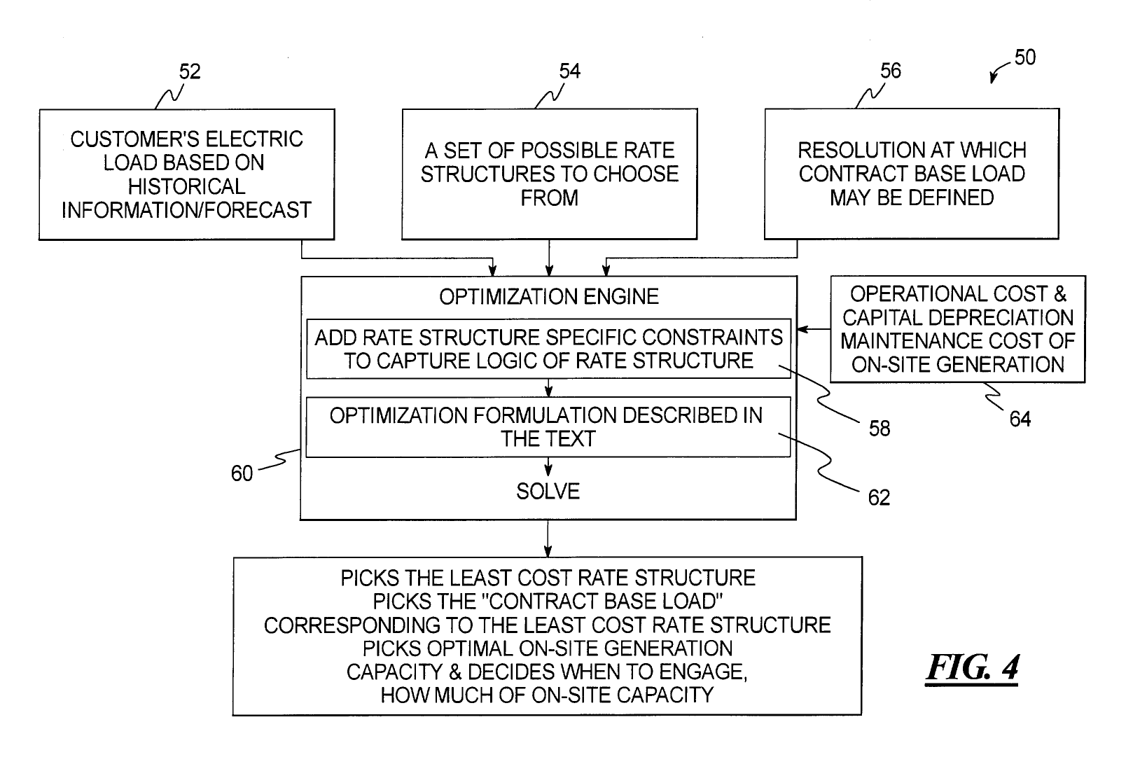

Such a search can be carried out in a computational architecture as depicted in FIG. 3. A heuristic search procedure 30 (such as Scatter Search, Tabu Search, or Genetic Algorithm) is used to search for the “right” set of deterministic input values (for the uncertain parameters) in a deterministic math program 32. The deterministic math program 32 implements one of the objective functions set out above and is an optimizer that solves for the optimal solution, which is fed into a Monte Carlo simulation module 34 for numerically calculating the value of the stochastic objective corresponding to the above deterministic optimal solution. The value of the stochastic objective is communicated to the heuristic search procedure 30, which then proceeds to determine the next iteration (or candidate).

With respect to the heuristic search procedure 30, the calculation of the stochastic objective for a given iteration is like a black-box calculation. The space of possible values that the input stochastic parameters can take is assumed to be bounded by the intervals over which their respective probability distributions are defined in the input. In other words, the heuristic search procedure 30 searches for the “right” point inside a bounded hyper-rectangle (whose dimensions are equal to the number of uncertain inputs). The heuristic search procedure 30 can also be made to search over a space having fewer dimensions, by grouping together uncertainties according to the same resolution at which the Contract Base Load solution to the objective function is being sought. In other words, in the search over the smaller space, all the uncertain parameters in a given group will have their k-th percentile value (say) as the deterministic value in any given iteration.

Such a procedure combines the relative merits of the mathematical programming and heuristic search algorithms. A neural network can also be used in the heuristic search procedure 30 to build the stochastic objective landscape over the space of possible values that the input stochastic parameters can assume. Such a landscape can assist the heuristic search procedure in determining its next iteration. Such a framework could reveal that it may be better to use worst case values in summer peak periods and most likely values in, say, other periods, because variations in hot summer periods may be the biggest contributor to variance.

In determining the lowest cost combination of rate structure and Contract Base Load based on the first and second objective functions disclosed above, the computer 12 may be arranged to execute an optimization program 50 shown as a flow chart in FIG. 4. At a block 52 of the optimization program 50, the customer enters its estimated customer load for the coming year. As discussed above, the estimated customer load may be based on the customer's historical demand data and may be generated by any utility demand forecasting module and/or predictive model available to the customer.

At a block 54 of the optimization program 50, the customer also enters the rate structures that have been offered to the customer by the utility. At a block 56, the customer further enters the temporal resolution that the utility uses in negotiating Contract Base Loads with its customers. FIG. 2 gives an example of one such temporal resolution that a utility might use. At a block 58 of an optimization engine 60, the user enters rate structure constraints in order to capture the logic of the rate structures offered by the utility. The optimization engine 60 at a block 62 minimizes one of the first two objective functions discussed above. This minimization has the effect of choosing the least cost rate structure as well as the Contract Base Load that corresponds to the least cost rate structure. The customer may use this rate structure and Contract Base Load to negotiate a favorable utility contract with the customer's utility.

In determining the lowest cost combination of rate structure and Contract Base Load based on the third objective function disclosed above, the user enters the Contract Base Load at the block 52, the rate structures at the block 54, and the temporal resolution for the Contract Base Load at the block 56, as before. The user at a block 64 also enters the various energy capacities Gas_Cap that the customer can purchase for the on-site generation of energy, the capital depreciation cost component Fᵢ, and the operational cost component A_{ijkq}.

The optimization engine 60 at a block 62 then minimizes the third objective function discussed above. This minimization has the effect of choosing the least cost rate structure as well as the Contract Base Load that corresponds to the least cost rate structure, as before. This minimization further has the effect of choosing the on-site generation capacity, decides when to engage the on-site generation equipment, and how much of the on-site generation to engage. The customer may use all of this information to negotiate a favorable utility contract with the customer's utility.

Certain modifications of the present invention has been described above. Other modifications of the invention will occur to those skilled in the art.

For example, the present invention can be used to reduce the utility costs of several. utility customers who unite to collectively negotiate contracts. In this case, the several utility customers add their individual estimated customer loads together and use the estimated total customer load in the objective functions described above.

Accordingly, the description of the present invention is to be construed as illustrative only and is for the purpose of teaching those skilled in the art the best mode of carrying out the invention. The details may be varied substantially without departing from the spirit of the invention, and the exclusive use of all modifications which are within the scope of the appended claims is reserved.

We claim:

1. A method of determining a lowest utility cost relative to a plurality of utility rate structures, to an estimated customer load, and to a temporal resolution of a Contract Base Load comprising:
computing a plurality of utility costs based on combinations of each of the rate structures, the estimated customer load, and the temporal resolution of the Contract Base Load; and,
selecting the rate structure and Contract Base Load producing the lowest utility cost.

2. The method of claim 1 wherein the computing of a plurality of utility costs comprises computing a plurality of utility costs based on an objective function having a first variable corresponding to the rate structures and a second variable corresponding to the Contract Base Load.

3. The method of claim 1 wherein the computing of a plurality of utility costs comprises computing a plurality of utility costs based on an objective function having a first variable corresponding to the rate structures, a second variable corresponding to the Contract Base Load, and a third variable corresponding to the estimated customer load.

4. The method of claim 1 wherein the computing of a plurality of utility costs comprises computing a plurality of utility costs based on an objective function, wherein the objective function comprises a first component dependent upon the Contract Base Load and an energy charge, a second component dependent upon a demand charge and a higher of the Contract Base Load and the estimated customer load, and a third component dependent upon a real time price and a difference between the Contract Base Load and the estimated customer load.

5. The method of claim 1 wherein the computing of a plurality of utility costs comprises computing a plurality of utility costs based on an objective function, wherein the objective function comprises a first component dependent upon Cₗₘ and hₗₘₙ, a second component dependent upon D_{lS(k)} and a higher value between dᵢ and h_{lS(k)n}, and a third component dependent upon Rᵢ and a difference between dᵢ and hₗₘₙ, wherein Cₗₘ comprises an energy charge, wherein hₗₘₙ comprises the Contract Base Load, wherein D_{lS(k)} comprises a demand charge, wherein dᵢ comprises the estimated customer load, wherein h_{lS(k)n} comprises the Contract Base Load, wherein Rᵢ comprises a real time price of energy, wherein l represents a time period of a day, wherein m represents time of year, wherein n represents day of week, wherein i represents a time bucket of predetermined duration, and wherein S(k) maps month k to the time of year m.

6. The method of claim 1 wherein the computing of a plurality of utility costs comprises computing a plurality of utility costs based on an objective function, wherein the objective function comprises a first component dependent upon hᵢⱼₖ, Eᵢⱼₖ, and Qᵢⱼₖ, a second component dependent upon d_{ijkq} and R_{ijkq}, and a third component dependent upon zᵢₗ and Pᵢₗ, wherein hᵢⱼₖ comprises the Contract Base Load, wherein Eᵢⱼₖ comprises an energy charge, wherein Qᵢⱼₖ comprises a set of temporal occurrences of any given (i,j,k), wherein d_{ijkq} comprises an amount of the estimated customer load purchased at a corresponding real time price R_{ijkq}, wherein zᵢₗ comprises the highest estimate demand in a period l, wherein Pᵢₗ comprises a demand charge, wherein i designates month, wherein j designates day, wherein k designates hour, and wherein q designates a temporal occurrence of day j, during hour k, in month i.

7. The method of claim 1 wherein the computing of a plurality of utility costs comprises computing a plurality of utility costs based on an objective function, wherein the objective function comprises a first component dependent upon hᵢⱼₖ, Eᵢⱼₖ, and Qᵢⱼₖ, a second component dependent upon d_{ijkq} and R_{ijkq}, a third component dependent upon zᵢₗ and Pᵢₗ, a fourth component dependent upon g_{ijkq} and A_{ijkq}, and a fifth component dependent upon Fᵢ and Gas_Cap, wherein hᵢⱼₖ comprises the Contract Base Load, wherein Eᵢⱼₖ comprises an energy charge, wherein Qᵢⱼₖ comprises a set of temporal occurrences of any given (i,j,k), wherein d_{ijkq} comprises an amount of the estimated customer load purchased at a corresponding real time price R_{ijkq}, wherein zᵢₗ comprises the highest estimated demand in a period l, wherein Pᵢₗ comprises a demand charge, wherein g_{ijkq} comprises on-site generation operational usage, wherein A_{ijkq} comprises a cost of the on-site generation operational usage, wherein Fᵢ comprises cost of capital depreciation and maintenance of on-site generation equipment, wherein Gas_Cap comprises on-site generation capacity of the on-site generation equipment, wherein i designates month, wherein j designates day, wherein k designates hour, wherein q designates a temporal occurrence of day j, during hour k, in month i.

8. The method of claim 1 wherein the Contract Base Load comprises a time-of-use Contract Base Load, wherein the computing of a plurality of utility costs comprises computing a plurality of utility costs based on an objective function, and wherein the objective function comprises a first component dependent upon a time-of-use energy charge and the time-of-use Contract Base Load, a second component dependent upon a time related demand charge and a higher value between the estimated customer load and the time-of-use Contract Base Load, and a third component dependent upon a real time price of energy and a difference between the estimated customer load and the time-of-use Contract Base Load.

9. The method of claim 1 wherein the Contract Base Load comprises a time-of-use Contract Base Load, wherein the computing of a plurality of utility costs comprises computing a plurality of utility costs based on an objective function, and wherein the objective function comprises a first component dependent upon the time-of-use Contract Base Load, a time-of-use energy charge, and a temporal occurrence, a second component dependent upon an amount of the estimated customer load purchased at a corresponding real time price, and a third component dependent upon a time related estimated highest demand and a time related demand charge.

10. The method of claim 1 wherein the Contract Base Load comprises a time-of-use Contract Base Load, wherein the computing of a plurality of utility costs comprises computing a plurality of utility costs based on an objective function, and wherein the objective function comprises a first component dependent upon the time-of-use Contract Base Load, a time-of-use energy charge, and a temporal occurrence, a second component dependent upon an amount of the estimated customer load purchased at a corresponding real time price, a third component dependent upon a time related estimated highest demand and a time related demand charge, a fourth component dependent upon time related on-site generation operational usage and a time related cost of the on-site generation operational usage, and a fifth component dependent upon time dependent capital depreciation and maintenance and on-site generation capacity.

11. The method of claim 1 wherein the computing of a plurality of utility costs comprises computing a plurality of utility costs based on an objective function, and wherein the objective function comprises a first component dependent upon the Contract Base Load and an energy charge, a second component dependent upon an amount of the estimated customer load purchased at a corresponding real time price, a third component dependent upon a highest estimated demand and a demand charge, a fourth component dependent upon on-site generation operational usage and a cost of the on-site generation operational usage, and a fifth component dependent upon capital depreciation and maintenance and on-site generation capacity.

12. The method of claim 1 further comprising:
implementing a heuristic search for inputs based on the utility rate structures and the Contract Base Load;
computing the utility costs based on the inputs as supplied by the heuristic search; and,
applying a simulation to the computed utility costs.

13. A computer implemented method of determining a lowest utility cost relative to a plurality of utility rate structures and an estimated customer load comprising:
computing a plurality of utility costs based on the plurality of utility rate structures and the estimated customer load such that each of the utility costs corresponds to a different combination of one of the utility rate structures and a Contract Base Load, wherein the computing of the plurality of utility costs is further based on a minimization of an objective function; and,
providing to a utility customer a rate structure and Contract Base Load combination corresponding to the lowest utility cost.

14. The method of claim 13 wherein the objective function comprises a first component dependent upon the Contract Base Load and an energy charge, a second component dependent upon a demand charge and a higher of the Contract Base Load and the estimated customer load, and a third component dependent upon a real time price and a difference between the Contract Base Load and the estimated customer load.

15. The method of claim 13 wherein the objective function comprises a first component dependent upon Cₗₘ and hₗₘₙ, a second component dependent upon D_{lS(k)} and a higher value between dᵢ and h_{lS(k)n}, and a third component dependent upon Rᵢ and a difference between dᵢ and hₗₘₙ, wherein Cₗₘ comprises an energy charge, wherein hₗₘₙ comprises the Contract Base Load, wherein D_{lS(k)} comprises a demand charge, wherein dᵢ comprises the estimated customer load, wherein h_{lS(k)n} comprises the Contract Base Load, wherein Rᵢ comprises a real time price of energy, wherein l represents a time period of a day, wherein m represents time of year, wherein n represents day of week, wherein i represents a time bucket of predetermined duration, and wherein S(k) maps month k to the time of year m.

16. The method of claim 13 wherein the objective function comprises a first component dependent upon hᵢⱼₖ, Eᵢⱼₖ, and Qᵢⱼₖ, a second component dependent upon d_{ijkq} and R_{ijkq}, and a third component dependent upon zᵢₗ and Pᵢₗ, wherein hᵢⱼₖ comprises the Contract Base Load, wherein Eᵢⱼₖ comprises an energy charge, wherein Qᵢⱼₖ comprises a set of temporal occurrences of any given (i,j,k), wherein d_{ijkq} comprises an amount of the estimated customer load purchased at a corresponding real time price R_{ijkq}, wherein zᵢₗ comprises a highest estimated demand, wherein Pᵢₗ comprises a demand charge, wherein i designates month, wherein j designates day, wherein k designates hour, wherein q designates a temporal occurrence of day j, during hour k, in month i.

17. The method of claim 13 wherein the objective function comprises a first component dependent upon hᵢⱼₖ, Eᵢⱼₖ, and Qᵢⱼₖ, a second component dependent upon d_{ijkq} and R_{ijkq}, a third component dependent upon zᵢₗ and Pᵢₗ, a fourth component dependent upon g_{ijkq} and A_{ijkq}, and a fifth component dependent upon Fᵢ and Gas_Cap, wherein hᵢⱼₖ comprises the Contract Base Load, wherein Eᵢⱼₖ comprises an energy charge, wherein Qᵢⱼₖ comprises a set of temporal occurrences of any given (i,j,k), wherein d_{ijkq} comprises an amount of the estimated customer load purchased at a corresponding real time price R_{ijkq}, wherein zᵢₗ comprises a highest estimated demand, wherein Pᵢₗ comprises a demand charge, wherein g_{ijkq} comprises on-site generation operational usage, wherein A_{ijkq} comprises a cost of the on-site generation operational usage, wherein Fᵢ comprises cost of capital depreciation and maintenance, wherein Gas_Cap comprises on-site generation capacity, wherein i designates month, wherein j designates day, wherein k designates hour, wherein q designates a temporal occurrence of day j, during hour k, in month i.

18. The method of claim 13 wherein the Contract Base Load comprises a time related Contract Base Load, and wherein the objective function comprises a first component dependent upon a time related energy charge and the time related Contract Base Load, a second component dependent upon a time related demand charge and a higher value between the estimated customer load and the time related Contract Base Load, and a third component dependent upon a real time price of energy and a difference between the estimated customer load and the time related Contract Base Load.

19. The method of claim 13 wherein the Contract Base Load comprises a time related Contract Base Load, and wherein the objective function comprises a first component dependent upon the time related Contract Base Load, a time related energy charge, and a temporal occurrence, a second component dependent upon an amount of the estimated customer load purchased at a corresponding real time price, and a third component dependent upon a time related highest estimated demand and a time related demand charge.

20. The method of claim 13 wherein the Contract Base Load comprises a time related Contract Base Load, and wherein the objective function comprises a first component dependent upon the time related Contract Base Load, a time related energy charge, and a temporal occurrence, a second component dependent upon an amount of the estimated customer load purchased at a corresponding real time price, a third component dependent upon a time related highest estimated demand and a time related demand charge, a fourth component dependent upon time related on-site generation operational usage and a time related cost of the on-site generation operational usage, and a fifth component dependent upon time dependent capital depreciation and maintenance and on-site generation capacity.

21. The method of claim 13 wherein the objective function comprises a first component dependent upon the Contract Base Load and an energy charge, a second component dependent upon an amount of the estimated customer load purchased at a corresponding real time price, a third component dependent upon a highest estimated demand and a demand charge, a fourth component dependent upon on-site generation operational usage and a cost of the on-site generation operational usage, and a fifth component dependent upon capital depreciation and maintenance and on-site generation capacity.

22. The method of claim 13 further comprising:
implementing a heuristic search for inputs to the objective function based on the utility rate structures and the Contract Base Load;
computing the utility costs by way of the objective function based on the inputs as supplied by the heuristic search; and,
applying a simulation to the computed utility costs.

23. A computer implemented method of determining a lowest utility cost relative to a plurality of utility rate structures, to an estimated customer load, to a plurality of on-site generation options, and to a temporal resolution of a Contract Base Load, the method comprising:
computing a plurality of utility costs such that each of the utility costs corresponds to a different combination of one of rate structures, a Contract Base Load, and one of the on-site generations options, wherein the computing of the plurality of utility costs is based on an objective function; and,
presenting to a utility customer a rate structure, a Contract Base Load, and on-site generation option combination corresponding to the lowest utility cost.

24. The method of claim 23 wherein the objective function comprises a first component dependent upon the Contract Base Load and an energy charge, a second component dependent upon a demand charge and a higher of the Contract Base Load and the estimated customer load, a third component dependent upon a real time price and a difference between the Contract Base Load and the estimated customer load, and a fourth component dependent on on-site generation.

25. The method of claim 23 wherein the objective function comprises a first component dependent upon Cₗₘ and hₗₘₙ, a second component dependent upon D_{lS(k)} and a higher value between dᵢ and h_{lS(k)n}, a third component dependent upon Rᵢ and a difference between dᵢ and hₗₘₙ, and a fourth component dependent on on-site generation, wherein Cₗₘ comprises an energy charge, wherein hₗₘₙ comprises the Contract Base Load, wherein D_{lS(k)} comprises a demand charge, wherein dᵢ comprises the estimated customer load, wherein h_{lS(k)n} comprises the Contract Base Load, wherein Rᵢ comprises a real time price of energy, wherein l represents a time period of a day, wherein m represents time of year, wherein n represents day of week, wherein i represents a time bucket of predetermined duration, and wherein S(k) maps month k to the time of year m.

26. The method of claim 23 wherein the objective function comprises a first component dependent upon hᵢⱼₖ, Eᵢⱼₖ, and Qᵢⱼₖ, a second component dependent upon d_{ijkq} and R_{ijkq}, a third component dependent upon zᵢₗ and Pᵢₗ, and a fourth component dependent on on-site generation, wherein hᵢⱼₖ comprises the Contract Base Load, wherein Eᵢⱼₖ comprises an energy charge, wherein Qᵢⱼₖ comprises a set of temporal occurrences of any given (i,j,k), wherein d_{ijkq} comprises an amount of the estimated customer load purchased at a corresponding real time price R_{ijkq}, wherein zᵢₗ comprises a highest estimated demand, wherein Pᵢₗ comprises a demand charge, wherein i designates month, wherein j designates day, wherein k designates hour, wherein q designates a temporal occurrence of day j, during hour k, in month i.

27. The method of claim 23 wherein the objective function comprises a first component dependent upon hᵢⱼₖ, Eᵢⱼₖ, and Qᵢⱼₖ, a second component dependent upon d_{ijkq} and R_{ijkq}, a third component dependent upon zᵢₗ and Pᵢₗ, a fourth component dependent upon g_{ijkq} and A_{ijkq}, and a fifth component dependent upon Fᵢ and Gas_Cap, wherein hᵢⱼₖ comprises the Contract Base Load, wherein Eᵢⱼₖ comprises an energy charge, wherein Qᵢⱼₖ comprises a set of temporal occurrences of any given (i,j,k), wherein d_{ijkq} comprises an amount of the estimated customer load purchased at a corresponding real time price R_{ijkq}, wherein zᵢₗ comprises a highest estimated demand, wherein Pᵢₗ comprises a demand charge, wherein g_{ijkq} comprises on-site generation operational usage, wherein A_{ijkq} comprises a cost of the on-site generation operational usage, wherein Fᵢ comprises cost of capital depreciation and maintenance, wherein Gas_Cap comprises on-site generation capacity, wherein i designates month, wherein j designates day, wherein k designates hour, wherein q designates a temporal occurrence of day j, during hour k, in month i.

28. The method of claim 23 wherein the Contract Base Load comprises a time related Contract Base Load, and wherein the objective function comprises a first component dependent upon a time related energy charge and the time related Contract Base Load, a second component dependent upon a time related demand charge and a higher value between the estimated customer load and the time related Contract Base Load, a third component dependent upon a real time price of energy and a difference between the estimated customer load and the time related Contract Base Load, and a fourth component dependent on on-site generation.

29. The method of claim 23 wherein the Contract Base Load comprises a time related Contract Base Load, and wherein the objective function comprises a first component dependent upon the time related Contract Base Load, a time related energy charge, and a temporal occurrence, a second component dependent upon an amount of the estimated customer load purchased at a corresponding real time price, a third component dependent upon a time related highest estimated demand and a time related demand charge, and a fourth component dependent on on-site generation.

30. The method of claim 23 wherein the Contract Base Load comprises a time related Contract Base Load, and wherein the objective function comprises a first component dependent upon the time related Contract Base Load, a time related energy charge, and a temporal occurrence, a second component dependent upon an amount of the estimated customer load purchased at a corresponding real time price, a third component dependent upon a time related highest estimated demand and a time related demand charge, a fourth component dependent upon time related on-site generation operational usage and a time related cost of the on-site generation operational usage, and a fifth component dependent upon time dependent capital depreciation and maintenance and on-site generation capacity.

31. The method of claim 23 wherein the objective function comprises a first component dependent upon the Contract Base Load and an energy charge, a second component dependent upon an amount of the estimated customer load purchased at a corresponding real time price, a third component dependent upon a highest estimated demand and a demand charge, a fourth component dependent upon on-site generation operational usage and a cost of the on-site generation operational usage, and a fifth component dependent upon capital depreciation and maintenance and on-site generation capacity.

32. The method of claim 23 further comprising:
implementing a heuristic search for inputs to the objective function based on the utility rate structures and the Contract Base Load;
computing the utility costs by way of the objective function based on the inputs as supplied by the heuristic search; and,
applying a simulation to the computed utility costs.

33. A method of determining a lowest utility cost for a plurality of customers relative to a plurality of utility rate structures, to a total estimated load corresponding to the plurality of customers, and to a temporal resolution of a Contract Base Load comprising:
computing a plurality of utility costs based on combinations of each of the rate structures, the estimated total customer load, and the temporal resolution of the Contract Base Load; and,
selecting the rate structure and Contract Base Load producing the lowest utility cost.

34. The method of claim 33 wherein the computing of a plurality of utility costs comprises computing a plurality of utility costs based on each of the rate structures, the estimated total customer load, the temporal resolution of the Contract Base Load, and one of a plurality of on-site generations options, and wherein the selecting of the rate structure and Contract Base Load producing the lowest utility cost comprises selecting a utility customer a rate structure, a Contract Base Load, and on-site generation option combination corresponding to the lowest utility cost.

35. The method of claim 34 wherein the computing of a plurality of utility costs comprises computing a plurality of utility costs based on an objective function having a first variable corresponding to the rate structures, a second variable corresponding to the Contract Base Load, and a third variable corresponding to on-site generation.

36. The method of claim 33 wherein the computing of a plurality of utility costs comprises computing a plurality of utility costs based on an objective function having a first variable corresponding to the rate structures and a second variable corresponding to the Contract Base Load.

37. The method of claim 33 wherein the computing of a plurality of utility costs comprises computing a plurality of utility costs based on an objective function having a first variable corresponding to the rate structures, a second variable corresponding to the Contract Base Load, and a third variable corresponding to the estimated total customer load.

38. The method of claim 33 wherein the computing of a plurality of utility costs comprises computing a plurality of utility costs based on an objective function, wherein the objective function comprises a first component dependent upon the Contract Base Load and an energy charge, a second component dependent upon a demand charge and a higher of the Contract Base Load and the estimated total customer load, and a third component dependent upon a real time price and a difference between the Contract Base Load and the estimated customer load.

39. The method of claim 33 wherein the computing of a plurality of utility costs comprises computing a plurality of utility costs based on an objective function, wherein the objective function comprises a first component dependent upon Cₗₘ and hₗₘₙ, a second component dependent upon D_{lS(k)} and a higher value between dᵢ and h_{lS(k)n}, and a third component dependent upon Rᵢ and a difference between dᵢ and hₗₘₙ wherein Cₗₘ comprises an energy charge, wherein hₗₘₙ comprises the Contract Base Load, wherein D_{lS(k)} comprises a demand charge, wherein dᵢ comprises the estimated total customer load, wherein h_{lS(k)n} comprises the Contract Base Load, wherein Rᵢ comprises a real time price of energy, wherein l represents a time period of a day, wherein m represents time of year, wherein n represents day of week, wherein i represents a time bucket of predetermined duration, and wherein S(k) maps month k to the time of year m.

40. The method of claim 33 wherein the computing of a plurality of utility costs comprises computing a plurality of utility costs based on an objective function, wherein the objective function comprises a first component dependent upon hᵢⱼₖ, Eᵢⱼₖ, and Qᵢⱼₖ, a second component dependent upon d_{ijkq} and R_{ijkq}, and a third component dependent upon zᵢₗ and Pᵢₗ, wherein hᵢⱼₖ comprises the Contract Base Load, wherein Eᵢⱼₖ comprises an energy charge, wherein Qᵢⱼₖ comprises a set of temporal occurrences of any given (i,j,k), wherein d_{ijkq} comprises an amount of the estimated total customer load purchased at a corresponding real time price R_{ijkq}, wherein zᵢₗ comprises the highest estimate demand in a period l, wherein Pᵢₗ comprises a demand charge, wherein i designates month, wherein j designates day, wherein k designates hour, and wherein q designates a temporal occurrence of day j, during hour k, in month i.

41. The method of claim 33 wherein the computing of a plurality of utility costs comprises computing a plurality of utility costs based on an objective function, wherein the objective function comprises a first component dependent upon hᵢⱼₖ, Eᵢⱼₖ, and Qᵢⱼₖ, a second component dependent upon d_{ijkq} and R_{ijkq}, a third component dependent upon zᵢₗ and Pᵢₗ, a fourth component dependent upon g_{ijkq} and A_{ijkq}, and a fifth component dependent upon Fᵢ and Gas_Cap, wherein hᵢⱼₖ comprises the Contract Base Load, wherein Eᵢⱼₖ comprises an energy charge, wherein Qᵢⱼₖ comprises a set of temporal occurrences of any given (i,j,k), wherein d_{ijkq} comprises an amount of the estimated total customer load purchased at a corresponding real time price R_{ijkq}, wherein zᵢₗ comprises the highest estimated demand in a period l, wherein Pᵢₗ comprises a demand charge, wherein g_{ijkq} comprises on-site generation operational usage, wherein A_{ijkq} comprises a cost of the on-site generation operational usage, wherein Fᵢ comprises cost of capital depreciation and maintenance of on-site generation equipment, wherein Gas_Cap comprises on-site generation capacity of the on-site generation equipment, wherein i designates month, wherein j designates day, wherein k designates hour, wherein q designates a temporal occurrence of day j, during hour k, in month i.

42. The method of claim 33 wherein the computing of a plurality of utility costs comprises computing a plurality of utility costs based on an objective function, and wherein the objective function comprises a first component dependent upon the Contract Base Load and an energy charge, a second component dependent upon an amount of the estimated total customer load purchased at a corresponding real time price, a third component dependent upon a highest estimated demand and a demand charge, a fourth component dependent upon on-site generation operational usage and a cost of the on-site generation operational usage, and a fifth component dependent upon capital depreciation and maintenance and on-site generation capacity.

43. The method of claim 33 further comprising:
implementing a heuristic search for inputs based on the utility rate structures and the Contract Base Load;
computing the utility costs based on the inputs as supplied by the heuristic search; and,
applying a simulation to the computed utility costs.
